(19) United States
(12) Patent Application Publication
(10) Pub. No.: US 2005/0036074 A1
(43) Pub. Date: Feb. 17, 2005

(54) Method and system for a digital interface for TV stereo audio decoding

(75) Inventor: Hoang Nhu, Irvine, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation

(21) Appl. No.: 10/646,721

(22) Filed: Aug. 25, 2003

Related U.S. Application Data
(60) Provisional application No. 60/495,121, filed on Aug. 15, 2003.

(51) Int. Cl. H04N 7/084

(52) U.S. Cl. 348/738; 348/484

(57) ABSTRACT

Provided is a method and system for implementing a digital interface to a BTSC decoder for analog television stereo audio signals. An exemplary system includes an I/F demodulator configured to (i) receive analog I/F signals and (ii) convert the received I/F signals to digital samples. These digital samples are input to a digital signal processor (DSP) for BTSC decoding into Left & Right audio outputs. This digital interface allows optimal stereo reparation between Left & Right outputs without the use of any signal level correction circuit.

### CROSS-REFERENCE TO RELATED APPLICATIONS

This application claims the benefit of U.S. Provisional Application No. 60/495,121, filed Aug. 15, 2003, which is incorporated herein by reference.

### BACKGROUND OF THE INVENTION

1. Field of the Invention

The present invention relates generally to the decoding of analog television (TV) stereo audio signals.

2. Related Art

Conventional analog TV stereo audio signals (discussed in greater detail below) primarily include two transmitted frequency components. These two components include a left channel audio signal and a right channel audio signal. The right and left channel audio signals combine to form the audio portion of analog television (TV) broadcasts. They are later encoded to represent a number of different audio channel formats.

The most prevalent audio channel formats include mono, stereo, and a secondary audio programming (SAP). Each of these channel formats is associated with a predetermined frequency spectrum. In preparation for transmission on a transmitter side, the associated frequency spectrums are frequency modulated (FM) and then up-converted to their respective channel frequencies. The transmitted channels are then received on a down-stream side, by a receiver, and are demodulated. The receiver side can include, e.g., a set top cable box, or the like. A first step in the decoding process is the FM demodulation to extract a base-band (programming information) broadcast television system committee (BTSC) signal from the FM signals.

The base-band BTSC signal at the output of the FM demodulator is traditionally in analog format. Feeding this analog signal to a digital signal processor (DSP) for BTSC decoding requires an analog-to-digital converter (ADC) to convert to digital samples. This conversion process usually introduces signal level mismatch/degradation that can significantly impair the quality of the BTSC-decoded signal in the DSP. Particularly, the signal mismatch/degradation can impair the stereo separation of the left and right outputs. Traditionally, what has been done to restore the correct signal level, thus improving stereo separation, is one of the following: manual adjustment of the signal level before the ADC conversion using a potentiometer or implementation of an automatic gain control (AGC) algorithm in the DSP.

What is needed therefore, is a technique to facilitate processing of the FM demodulated analog stereo audio TV signals in a digital domain. More specifically, what is needed is a technique to facilitate use of an all digital interface between the demodulator and the DSP which results in optimal stereo separation.

### BRIEF SUMMARY OF THE INVENTION

Consistent with the principles in the present invention as embodied and broadly described herein, an embodiment of the present invention includes a BTSC decoder. The decoder includes an intermediate frequency (I/F) demodulator configured to receive analog I/F signals and convert the received I/F signals to digital samples. Also included is a DSP. The DSP decodes the BTSC-encoded digital samples into audio samples with optimal stereo separation. The digital interface is configured to couple the I/F demodulator and the DSP. The digital interface permits the transfer of the digital samples purely in digital domain.

Further features and advantages of the present invention as well as the structure and operation of various embodiments of the present invention are described in detail below with reference to the accompanying drawings.

### BRIEF DESCRIPTION OF THE DRAWINGS/FIGURES

The accompanying drawings, which are incorporated in and constitute part of the specification, illustrate embodiments of the present invention and, together with the general description given above and detailed description of the embodiments given below, serve to explain the principles of the invention. In the drawings:

FIG. 1 is a graphical illustration of the frequency spectrum of transmitted analog television signals;

FIG. 2 is a block diagram illustration of a transmitter that sends signals that are processed by a decoder;

FIG. 3 is a block diagram illustration of an analog television audio decoder;

FIG. 4 is a block diagram illustration of an exemplary television signal decoder constructed and arranged in accordance with an embodiment of the present invention; and

FIG. 5 is flow diagram of an exemplary method of practicing an embodiment of the present invention.

### DETAILED DESCRIPTION OF THE PREFERRED EMBODIMENTS

The following detailed description of the present invention refers to the accompanying drawings that illustrate exemplary embodiments consistent with this invention. Other embodiments are possible, and modifications may be made to the embodiments within the sphere and scope of the invention. Therefore, the following detailed description is not meant to limit the invention. Rather, the scope of the invention is defined by the appended claims.

It will be apparent to one skilled in the art that the present invention, is described below, may be implemented in many different embodiments of hardware, software, firmware, and/or the entities illustrated in the drawings. Any actual software code with the specialized, controlled hardware to implement the present invention is not limiting of the present invention. Thus, the operation and behavior of the present invention will be described with the understanding that modifications and variations of the embodiments are possible, given the level of detail presented herein.

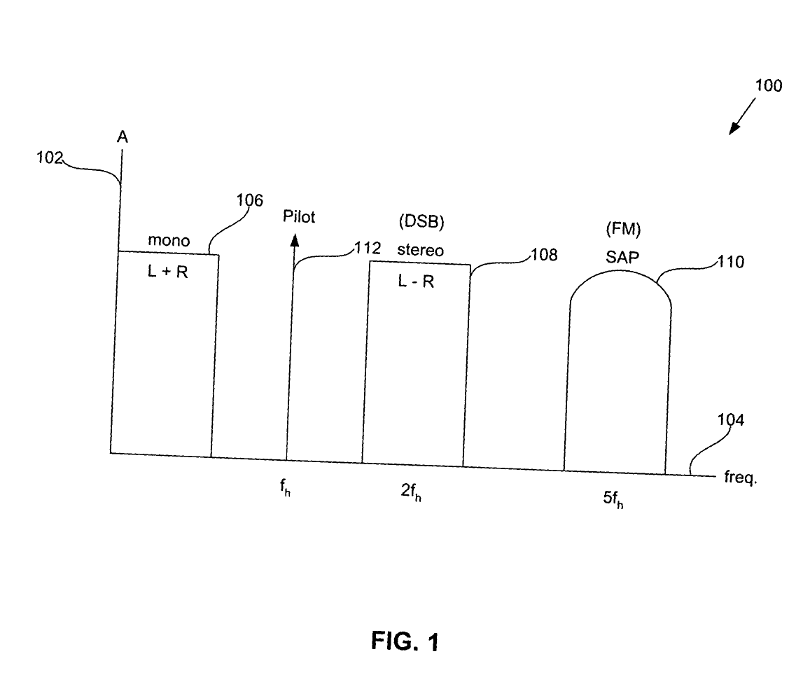

By way of background, FIG. 1 is a graphical illustration 100 of the frequency spectrum of transmitted television (TV) signals in accordance with United States (U.S.) TV transmission standards. In FIG. 1, the graph 100 illustrates the frequency spectrum of analog TV audio signals, and includes an amplitude axis 102 and frequency axis 104. Also included is a depiction of the analog TV signals corresponding to the mono, stereo, and SAP channel formats noted above.

Here, channel frequency bands 106, 108, and 110 respectively represent the mono, stereo, and SAP audio channels. Each of the channel bands 106, 108, and 110, includes various combinations of left channel signal data, including left channel programming information and right channel signal data, including right channel programming information. In the case of the mono channel band 106, monaural audio is produced as a function of the left signal plus the right signal divided by 2 (mono=sum=(L+R/2). The presence of a pilot signal 112 indicates stereo mode in which case stereo channel 108 exists. The stereo channel 108 carries the difference between L & R; this (L−R)/2 signal is transmitted as a dual-sideband suppressed carrier (DSB) with center at 2(fₕ). To recover L & R, the decoder performs the following operation: L=mono+stereo; and R=mono−stereo.

A SAP channel band 110 is an FM modulated frequency signal at carrier frequency of 5 (fₕ). In U.S. television audio transmissions, the SAP channel band 108 can be used to simultaneously transmit alternative audio programming (e.g., Spanish language audio).

Finally, as noted above, the pilot signal 112 at frequency (fₕ) indicates stereo mode and, therefore, the existence of the channel 108. As will be discussed in further detail below, the pilot signal 112 can also be used as part of a technique to compensate for audio signal losses. The signals 106, 108, 110, and 112, are all FM modulated onto an aural carrier signal and then transmitted to a receiver.

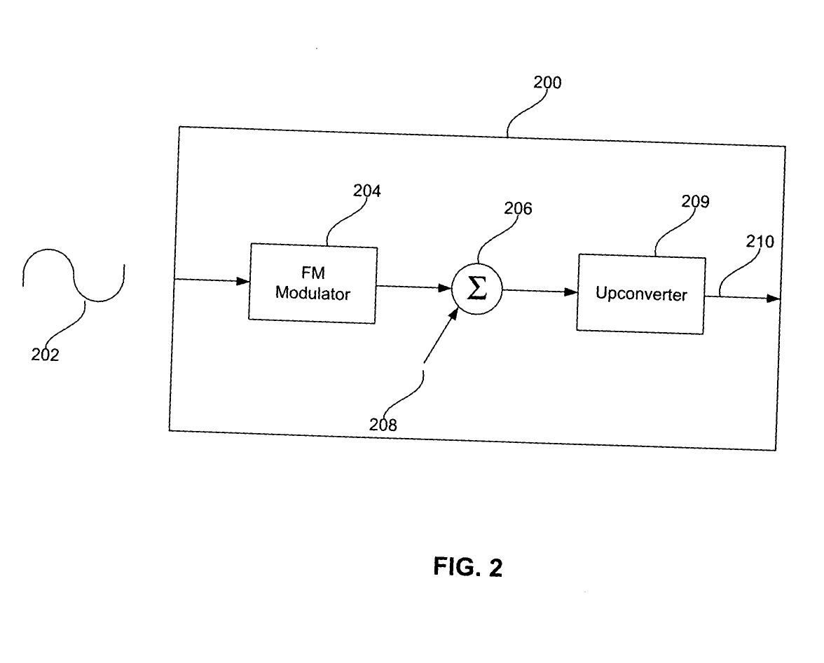

FIG. 2 is a block diagram illustration of the audio portion of a transmitter 200 configured to receive a BTSC signal 202 as an input. The input signal 202 whose spectrum is shown in FIG. 1, is FM modulated by a modulator 204. Next, a summing mechanism 206 combines an FM modulated audio signal output from the modulator 204 with a corresponding video signal component 208. An up-converter 209 up-converts the combined audio and video signals to form a transmission signal 210 having a predetermined frequency suitable for an over-the-air TV transmission.

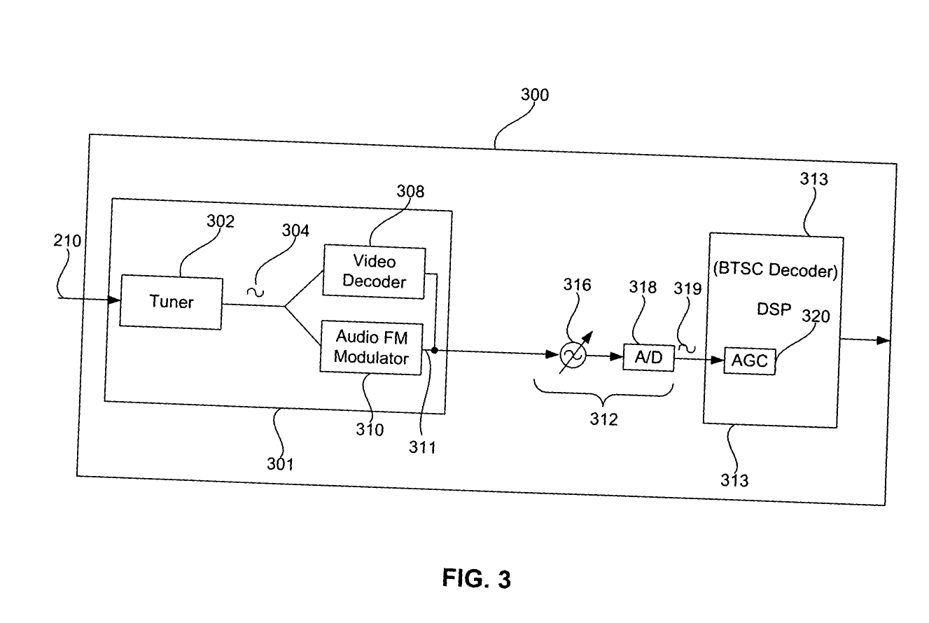

FIG. 3 is a block diagram illustration of a receiver 300 configured for receiving and decoding the transmitted signal 210. In FIG. 3, the receiver 300 includes a demodulator 301 for decoding the received signal 210. Included within the demodulator 301 is a tuner 302 for receiving the signal 210, and for FM demodulating the signal 304 to a base-band audio signal 311. The demodulator 301 also includes a video decoder portion 308.

For an analog receiver 300, the audio FM demodulator 310 demodulates the IF signal into the base-band BTSC-encoded signal 311. The interface 312, consisting of a potentiometer 316, and ADC 318, serves to couple the demodulator 310 to the DSP 313. Either the potentiometer 316 or the AGC 320, implemented in the DSP 313, is used to restore signal level 319 to a level that gives best stereo separation between L & R outputs of the DSP 313.

The AGC 320 attempts to restore the signal 319 to the correct level by monitoring the level of the pilot signal 112. Even with such correction, the resulting separation may be on the order of only about 20 dB. The present invention provides a digital interface that eliminates the analog-to-digital conversion that otherwise occurs within the interface 312 of FIG. 3.

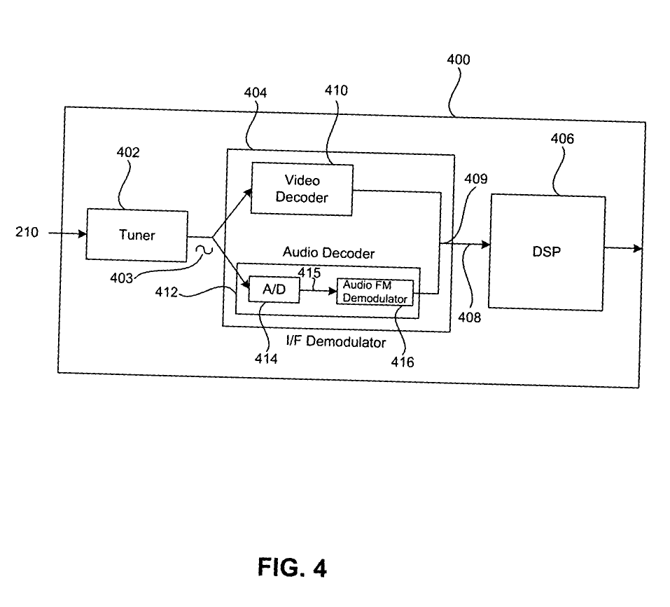

FIG. 4 is an illustration of an exemplary decoder 400, constructed and arranged in accordance with an embodiment of the present invention. The decoder 400 is an alternative to the decoder 300 of FIG. 3. The decoder 400 includes a tuner 402 configured to receive the signal 210, of FIG. 2, as an input. The tuner 402 down-converts the received signal 210 to an intermediate frequency (I/F) band signal 403.

Also included in the decoder 400 is an I/F demodulator 404 and a DSP 406. The I/F demodulator 404 and the DSP 406 are coupled together via a digital interface 408. The I/F demodulator 404 includes a video decoder portion 410 and a functionally similar audio FM demodulator 412.

Additional details of the I/F demodulator 404 are provided in U.S. Non-Provisional Application entitled “Digital IF Demodulator with Carrier Recovery,” Ser. No. 10/448,062, filed May 30, 2003, which is incorporated by reference herein in its entirety, assigned to Broadcom Corporation.

Next, a digital interface 408 is provided to couple the I/F demodulator 404 to the DSP 406. An output 409 of the I/F demodulator 404 is scalable. Its scalability facilitates signal level adjustments in order to ensure compatibility of the IF demodulator 406 with different down-stream DSP devices. Additionally, the output 409 of the I/F demodulator 404 is a digital signal, including composite BTSC samples that are compatible with multi-channel television sound (MTS) standards. Because the output 409 of the decoder 404 includes digital composite samples, the digital interface 408 can provide signals to the DSP 406 in the digital domain.

That is, the interface 408 does not include the use of the potentiometer 316, or the ADC 318, illustrated in FIG. 3. Since the interface 408 is purely digital, the conversion mismatch associated with the interface 312 of FIG. 3 are substantially reduced.

The all digital interface 408 of FIG. 4, by eliminating the requirement of ADC, and potentiometers, improves stereo separation within the original left signal channel and right signal channel of analog audio TV signals. The digital interface 408 can provide stereo separation up to, for example, 35 dB without the use of an AGC or a potentiometer.

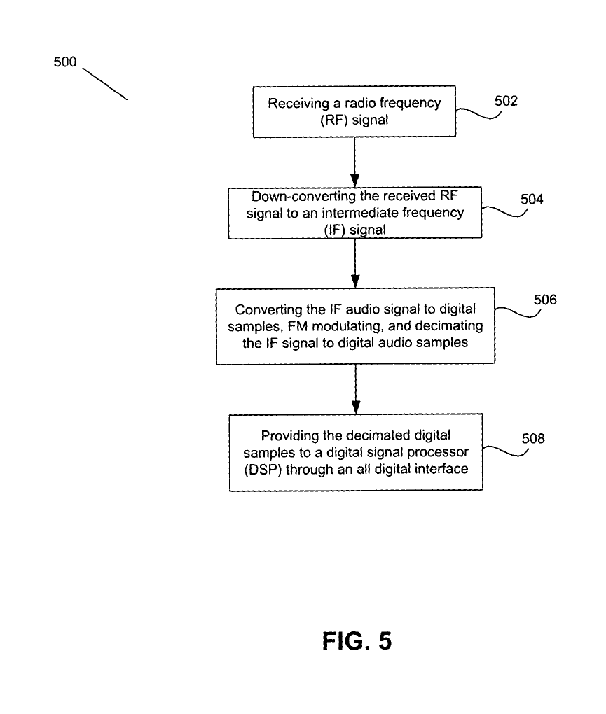

FIG. 5 is flow diagram 500 of an exemplary method of practicing an embodiment of the present invention. In FIG. 5, an RF signal is received in a block 502 and is down converted to an IF audio signal in a block 504. In blocks 506, the IF signal is FM modulated to digital audio samples and is decimated to a lower data rate. In a block 508, the digital samples are provided to a DSP through an all digital interface.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed.

Any such alternate boundaries are thus within the scope and spirit of the claimed invention. One skilled in the art will recognize that these functional building blocks can be implemented by analog and/or digital circuits, discrete components, application-specific integrated circuits, firmware, processor executing appropriate software, and the like, or any combination thereof. Thus, the breadth and scope of the present invention should not be limited by any of the above-described exemplary embodiments, but should be defined only in accordance with the following claims and their equivalents.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of he present specification is to be interpreted by the skilled artisan in light of the teachings and guidance presented herein, in combination of one of ordinary skill in the art.

1. A broadcast television system committee (BTSC) decoder, comprising:
an intermediate frequency (I/F) demodulator configured to convert and demodulate received I/F signals to digital audio samples;
a digital signal processor (DSP) configured to BTSC-decode the digital samples; and
an all digital interface that couples the I/F demodulator to the DSP.

2. The decoder of claim 1, wherein the received analog I/F signal is a carrier signal.

3. The decoder of claim 1, wherein the digital samples are composite BTSC samples formatted in accordance with multi-channel television sound (MTS) standards.

4. The decoder of claim 1, wherein the digital interface does not include a digital to analog converter (DAC).

5. The decoder of claim 1, wherein the digital interface does not include a gain control device.

6. The decoder of claim 1, wherein the digital interface does not include an analog to digital converter (ADC).

7. The decoder of claim 1, wherein the DSP does not include an automatic gain control (AGC) device.

8. A BTSC decoder including an (i) intermediate frequency (I/F) demodulator configured for demodulating received analog I/F signals and converting the received I/F analog signals to digital form and (ii) a digital signal processor (DSP) configured to process the digital signals, the decoder comprising a digital interface configured to couple the I/F demodulator and the DSP.

9. The decoder of claim 8, wherein the DSP does not include an automatic gain control device.

10. The decoder of claim 8, further comprising a scalable digital output.

11. The decoder of claim 8, wherein the digital interface is all digital.

12. The decoder of claim 8, wherein the digital interface does not include a digital to analog converter (DAC).

13. The decoder of claim 8, wherein the digital interface does not include an analog to digital converter (ADC).

14. The decoder of claim 8, wherein the digital interface permits the digital signal to be transferred from the I/F demodulator to the DSP in a purely digital domain.

15. A method for decoding an analog television audio signal, comprising:
receiving a radio frequency (RF) signal;
down-converting the received RF audio signal to an intermediate frequency signal;
converting the IF audio signal to digital samples;
FM modulating and decimating the digital samples to a lower data rate; and
providing the decimated digital samples to a digital signal processor (DSP) through an all digital interface.
